(19) United States
(12) Patent Application Publication
(10) Pub. No.: US 2010/0129508 A1
(43) Pub. Date: May 27, 2010

(54) Coating of Confectionery and Tablets

(75) Inventor: Paul Galluzzo, Cambridgeshire (GB)

Correspondence Address: WRIGLEY & DREYFUS 28455;BRINKS HOFER GILSON & LIONE, P.O. BOX 10395, CHICAGO, IL, 60610, US

(73) Assignee: Wm. Wrigley Jr. Company

(21) Appl. No.: 12/531,860

(22) PCT Filed: Mar. 19, 2008
(86) PCT No.: PCT/GB08/00971

§ 371 Date: Jan. 22, 2010

(30) Foreign Application Priority Data
Mar. 19, 2007 (GB) 0705234.3

(51) Int. Cl. A23P 1/08; A23P 1/12

(52) U.S. Cl. 426/307

(57) ABSTRACT

A method of coating an edible item. The method comprises applying molten polyol to the item and cooling the polyol to crystallise it into its solid form.

The present invention relates to the coating of confectionery and tablets with polyols. Polyols are a general class of chemical compounds that includes sugar alcohols. Sugar alcohols are low calorie sweeteners, that can be used in place of sugar itself. Examples of sugar alcohols include xylitol, mannitol, erythritol, maltitol, and sorbitol.

At present, pan coating is widely used to coat items such as chewing gum pellets, pharmaceutical tablets, and dragees (a form of confectionery). Pan coating typically results in a layer of candy-coating which can improve the flavour, provide crunchiness, and improve appearance. The state of the art at the moment in the confectionary industry is Driam coating (Driam is the name of a manufacturer), whereby the pan coating process is automated and semi-optimized for speed and consistency. Typical times required to coat a batch of confectionary is 5 hours with a Driam, and 10 hours with a pan coater.

In a typical Driam or pan, the confectionary items or tablets tumble whilst being sprayed with syrup. A small amount of syrup is applied every few minutes, which dries before the next amount of syrup is applied. This requirement for drying comes from the need for moisture to diffuse through the syrup to the surface and then to evaporate; and is largely responsible for the slowness of the process. The tumbling means there is continuously stress on the item. If they are not strong enough they may break or deform ,for example pharmaceutical tablets may chip.

There are a number of problems associated with pan coating. Firstly, it is slow. It takes several hours to build up a significant coating, due to the constant need to wait for moisture to diffuse to the surface and evaporate. Secondly, it is a batch process, a continuous process would potentially offer greater flexibility, process control, and reduce the chances that an entire batch will be lost.

Also, the process can cause damage. Pharmaceutical tablets can chip during pan coating, and chewing gum that is too soft can break or deform during pan coating. In the latter case this leads to a requirement that the gum must be hardened before the coating process, adding additional process steps. The process can also cause twinning , where tablets can stick together due to being sticky with syrup during the pan/Driam coating process, and result in pairs that are stuck together.

According to the present invention there is provided a method of coating an edible item, the method comprising:

applying molten polyol to the item; and

cooling the polyol to crystallise it into its solid form.

The method may employ dipping, casting or co-extruding to apply the molten polyol.

The polyol may be one of: Erythritol, Xylitol, Mannitol, Sorbitol, Maltitol, Isomalt, Sucrose.

Instead of spraying syrup (a polyol or sugar dissolved in water) as in the pan coating process, the invention applies molten polyol, allowing the molten polyol to cool, and then crystallize into a solid form.

This has a number of advantages, as follows. The first is speed, instead of waiting for moisture to diffuse, the invention waits for heat to diffuse. Heat diffusion is much quicker than moisture diffusion. The invention also waits for the crystallization process to occur; the time required to crystallize is determined by the choice of material.

The invention can be a continuous process. By being fast, a melt crystallization based process can be operated in a continuous inline format, with discreet stations devoted to successive parts of the process (e.g. molten polyol application and cooling)

There is also less damage, by avoiding the need for tumbling, the stress on the item to be coated during coating is reduced, and twinning is avoided as potentially each item can be handled individually due to the inline nature of the process.

The present invention will now be described with reference to the accompanying drawings, in which:

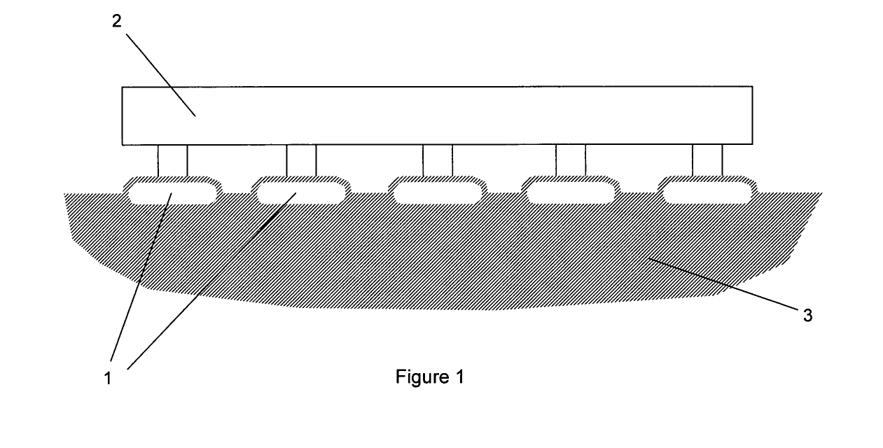

FIGS. 1 to 3 show schematic examples of processes employing the present invention.

The present invention exploits a melt crystallization process which relies on rapid crystallization of the polyol. Materials that crystallize quickly from melt tend to be those with a large ratio of melting point Tₘ to glass transition temperature T_{g}. A table of polyols is shown below. From this it can be seen that particular polyols, such as mannitol and erythritol, have large Tₘ/T_{g} ratios and are particularly well suited to melt crystallization. Maltitol for example, may be less suitable, but could still be employed if required by other aspects of the process.

| | Erythritol | Xylitol | Mannitol | Sorbitol | Maltitol | Isomalt | Sucrose |
|---|---|---|---|---|---|---|---|
| Melting point, Tₘ (° C.) | 121 | 94 | 165 | 97 | 150 | 145-150 | 190 |
| Glass transition, T_{g} (° C.) | −42 | −22 | −39 | −5 | 47 | 34 | 52 |
| Ratio Tₘ/T_{g} | 1.706 | 1.462 | 1.872 | 1.381 | 1.322 | 1.370 | 1.425 |
| Rank | 2 | 3 | 1 | 5 | 7 | 6 | 4 |

Methods of applying the invention will now be described. It should be noted that a melt-crystallization-based process according to the invention could be used either to replace the entire pan coating process or replace only a portion of it, e.g. to produce the first quarter of the coating thickness. This approach could be used to strengthen the item by adding an initial coating before entering the pan/Driam, which could be beneficial.

A coating process based on rapid melt crystallization could be realized through a large number of processes. These could include dip coating or enrobing, casting/thermoforming shells, or co-extrusion. Following these formation processes, in order to ensure a smooth coating it may be that individual pellets are passed down a tube to ensure adequate cooling whilst maintaining an even surface coating. These three formation processes will be described briefly below.

FIG. 1 shows a dipping process in which items 1 to be coated are held in a frame 2 and then placed in a pool 3 of molten polyol. Once an even coat of molten polyol 3 has been applied to each item 1 the frame 2 is removed and the items 1 cooled so that the polyol can solidify.

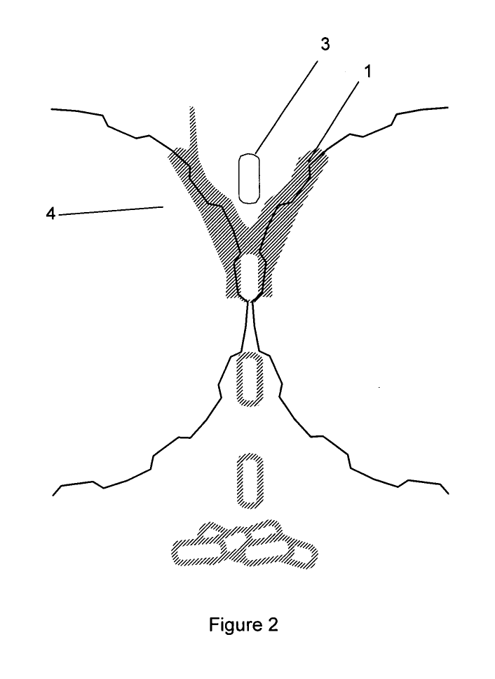

FIG. 2 shows an alternative process in which a casting technique is provided to apply molten polyol 3 to items 1. In this case the items 1 are passed through rotating moulds 4 which provide a “cast” of polyol around each item 1, then cooling it to set around each item 1 and to form an encapsulated item.

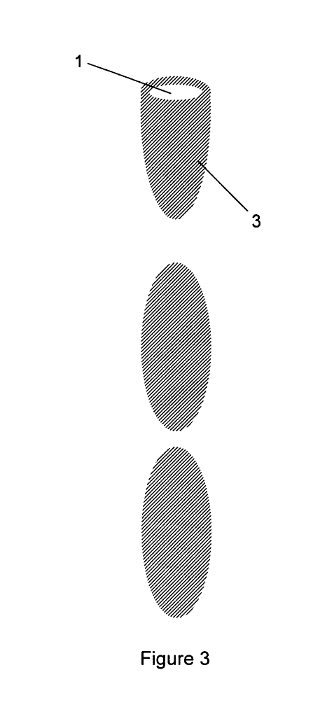

FIG. 3 shows a further process in which co-extruding is employed. In this example, co-axial nozzles (not shown) extrude item components 1 through the inner nozzle and molten polyol 3 through the outer nozzle, the polyol 3 cooling and solidifying arount the item 1 to form an encapsulated product. In this case the extrusion process may be pulsed to form discrete pellets 1, although this may be supplemented by an additional pinching step to separate individual pellets following on from extrusion. If the length of extruded material is sufficiently large then a cooling tunnel may not be necessary, with pinching occurring when the polyol has cooled to a predetermined amount to ensure even formation and accurate manufacture.

1. A method of coating an edible item, the method comprising:
a) applying molten polyol to the item by an application method selected from the group consisting of casting and co-extrusion; and
b) cooling the polyol to crystallize it into its solid form.

2. (canceled)

3. The method of claim 1, wherein the application method comprises casting.

4. The method of claim 1, wherein the application method comprises co-extrusion.

5. The method of claim 1, wherein the polyol is selected from the group consisting of erythritol, xylitol, mannitol, sorbitol, maltitol and isomalt.

6. The method of claim 1, wherein the applying and cooling steps are performed as continuous processes.

7. The method of claim 3, wherein the edible item is passed through rotating molds which provide a cast of polyol around each edible item.

8. The method of claim 4, wherein the edible item is extruded through an inner nozzle, and molten polyol is extruded through an outer nozzle, of co-axial nozzles, creating the encapsulated item.

9. The method of claim 8, wherein the extrusion process is pulsed to form discrete pellets.
